(19) United States
(12) Patent Application Publication
(10) Pub. No.: US 2026/0313065 A1
(43) Pub. Date: Oct. 8, 2026

(54) SMOOTHING OF PASSTHROUGH FRAME SEQUENCES IN VIDEO SEE-THROUGH (VST) EXTENDED REALITY (XR) OR OTHER APPLICATIONS

(71) Applicant: Samsung Electronics Co., Ltd., Suwon-si (KR)

(72) Inventor: Yingen Xiong, Mountain View, CA (US)

(21) Appl. No.: 19/559,632

(22) Filed: Mar. 6, 2026

Related U.S. Application Data
(60) Provisional application No. 63/785,413, filed on Apr. 8, 2025.

(51) Int. Cl. H04N 1/60; G06T 5/70; G06T 5/92; G06V 10/56; G06V 10/60

(52) U.S. Cl. CPC H04N 1/60; G06T 5/70; G06T 5/92; G06V 10/56; G06V 10/60; G06T 2207/10024

(57) ABSTRACT

A method includes obtaining a sequence of image frames and determining one or more color differences and one or more luminance differences for each of one or more overlapping areas between at least one pair of consecutive image frames in the sequence. The method also includes generating one or more parameters for a color matching model based on the one or more color differences and generating one or more parameters for a luminance matching model based on the one or more luminance differences. The method further includes applying the color matching model and the luminance matching model to at least one of the image frames to generate at least one color-matched and luminance-matched image frame.

### CROSS-REFERENCE TO RELATED APPLICATION AND PRIORITY CLAIM

This application claims priority under 35 U.S.C. § 119(e) to U.S. Provisional Patent Application No. 63/785,413 filed on Apr. 8, 2025, which is hereby incorporated by reference in its entirety.

### TECHNICAL FIELD

This disclosure relates generally to image processing systems and processes. More specifically, this disclosure relates to smoothing of passthrough frame sequences in video see-through (VST) extended reality (XR) or other applications.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to smoothing of passthrough frame sequences in video see-through (VST) extended reality (XR) or other applications.

In a first embodiment, an electronic device includes at least one processing device configured to obtain a sequence of image frames and determine one or more color differences and one or more luminance differences for each of one or more overlapping areas between at least one pair of consecutive image frames in the sequence. The at least one processing device is also configured to generate one or more parameters for a color matching model based on the one or more color differences and generate one or more parameters for a luminance matching model based on the one or more luminance differences. The at least one processing device is further configured to apply the color matching model and the luminance matching model to at least one of the image frames to generate at least one color-matched and luminance-matched image frame.

In a second embodiment, a method includes obtaining, using at least one processing device of an electronic device, a sequence of image frames and determining, using the at least one processing device, one or more color differences and one or more luminance differences for each of one or more overlapping areas between at least one pair of consecutive image frames in the sequence. The method also includes generating, using the at least one processing device, one or more parameters for a color matching model based on the one or more color differences and generating, using the at least one processing device, one or more parameters for a luminance matching model based on the one or more luminance differences. The method further includes applying, using the at least one processing device, the color matching model and the luminance matching model to at least one of the image frames to generate at least one color-matched and luminance-matched image frame.

In a third embodiment, a non-transitory machine readable medium contains instructions that when executed cause at least one processor of an electronic device to obtain a sequence of image frames and determine one or more color differences and one or more luminance differences for each of one or more overlapping areas between at least one pair of consecutive image frames in the sequence. The non-transitory machine readable medium also contains instructions that when executed cause the at least one processor to generate one or more parameters for a color matching model based on the one or more color differences and generate one or more parameters for a luminance matching model based on the one or more luminance differences. The non-transitory machine readable medium further contains instructions that when executed cause the at least one processor to apply the color matching model and the luminance matching model to at least one of the image frames to generate at least one color-matched and luminance-matched image frame.

Any single one or any combination of the following features may be used with the first, second, or third embodiment.

A frame registry may be updated based on a frame registration of one image frame in the sequence relative to a previous image frame in the sequence. Pixel correspondences between the at least one pair of consecutive image frames may be determined based on the frame registry. The one or more overlapping areas may be determined based on the pixel correspondences.

The parameters of the color matching model and the luminance matching model may be optimized. The optimized parameters of the color matching model and the luminance matching model may be stored for processing of a subsequent image frame in the sequence.

To apply the color matching model to the at least one of the image frames, a color smoothing model may be generated based on the one or more parameters of the color matching model. One or more color errors between the at least one pair of consecutive image frames may be determined. A minimization algorithm may be applied to the one or more color errors to generate one or more parameters of the color smoothing model. The color smoothing model may be applied as a linear correction to the one or more color errors.

To apply the luminance matching model to the at least one of the image frames, a luminance smoothing model may be generated based on the one or more parameters of the luminance matching model. One or more luminance errors between the at least one pair of consecutive image frames may be determined. A minimization algorithm may be applied to generate one or more parameters of the luminance smoothing model. The luminance smoothing model may be applied as a gamma correction to the one or more luminance errors.

The color matching model and the luminance matching model may be applied by smoothing colors between different ones of the image frames and smoothing luminances between different ones of the image frames.

The one or more parameters for the color matching model may be generated by applying linear correction in the one or more overlapping areas. The one or more parameters for the luminance matching model may be generated by applying gamma correction in the one or more overlapping areas.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example process for smoothing of a passthrough image sequence for video see-through (VST) extended reality (XR) or other applications in accordance with this disclosure;

FIGS. 3A and 3B illustrate an example architecture for smoothing of a passthrough image sequence for VST XR or other applications in accordance with this disclosure;

FIG. 4 illustrates an example process for color and light matching between image frames in accordance with this disclosure;

FIG. 5 illustrates an example registration of image frames in accordance with this disclosure;

FIGS. 6A and 6B illustrate an example overlapping of image frames in accordance with this disclosure;

FIG. 7 illustrates an example process for generating smoothing models in accordance with this disclosure;

FIG. 8 illustrates an example color matching between image frames using color matching models in accordance with this disclosure;

FIG. 9 illustrates an example luminance matching between image frames using light matching models in accordance with this disclosure;

FIG. 10 illustrates an example process for color and luminance enhancement of image frames in accordance with this disclosure;

FIG. 11 illustrates an example color smoothing between image frames in accordance with this disclosure;

FIG. 12 illustrates an example luminance smoothing between image frames in accordance with this disclosure; and

FIG. 13 illustrates an example method for smoothing of passthrough frame sequences in VST XR or other applications in accordance with this disclosure.

### DETAILED DESCRIPTION

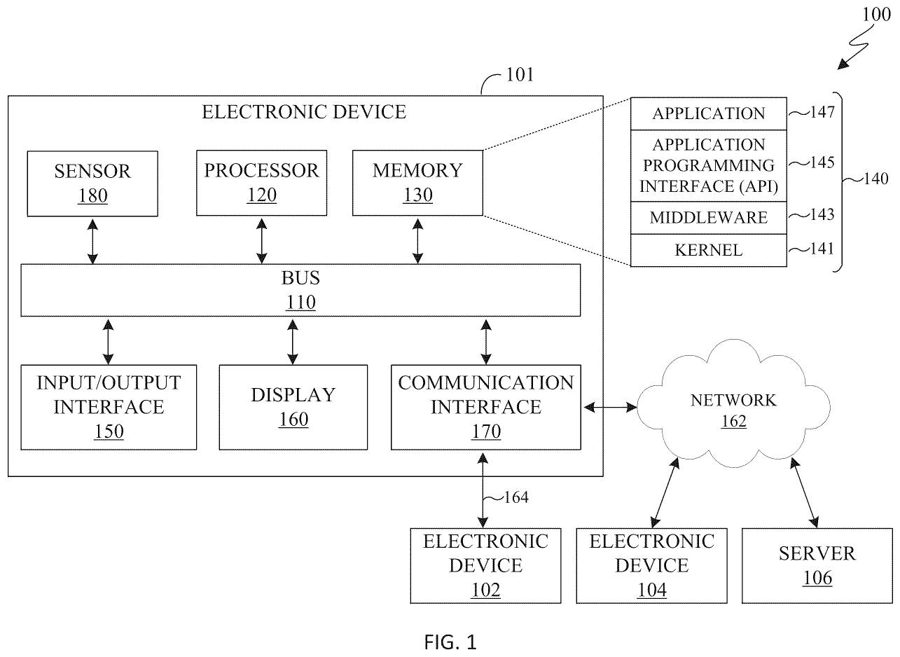

FIGS. 1 through 13, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. A VST XR device enables users to view their surroundings through captured color frames. Unfortunately, VST XR devices can suffer from various problems. One problem is that the image quality of the captured image frames can be affected by conditions in the surrounding environment and camera characteristics. For example, sudden changes in color and lighting can lead to abrupt color shifts between image frames, resulting in an uncomfortable experience for the users. Some visual enhancement approaches require generating a frame from multiple captured image frames with different exposures. However, these approaches may not be feasible in VST XR scenarios or other scenarios in which multiple image frames with different exposures may not be available.

This disclosure provides various techniques for smoothing of passthrough frame sequences in VST XR or other applications. As described in more detail below, a sequence of image frames may be obtained, and one or more color differences and one or more luminance differences for each of one or more overlapping areas between at least one pair of consecutive image frames in the sequence may be determined. One or more parameters for a color matching model may be generated based on the one or more color differences, and one or more parameters for a luminance matching model may be generated based on the one or more luminance differences. The color matching model and the luminance matching model may be applied to at least one of the image frames to generate at least one color-matched and luminance-matched image frame. In this way, improvements in brightness and color within the image frames can be obtained, resulting in clearer or otherwise improved image frames. Among other things, this can make the resulting image frames more visually appealing for users and reduce abrupt color or luminance shifts between image frames.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to smoothing of passthrough frame sequences in VST XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform smoothing of passthrough frame sequences in VST XR or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to smoothing of passthrough frame sequences in VST XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

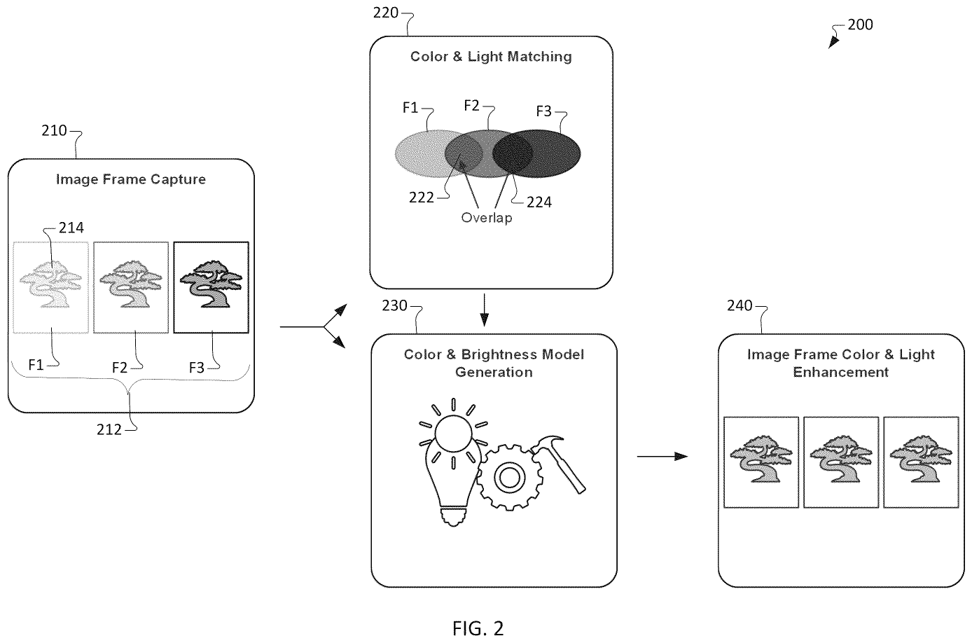

FIG. 2 illustrates an example process 200 for smoothing of a passthrough image sequence for VST XR or other applications in accordance with this disclosure. For ease of explanation, the process 200 shown in FIG. 2 is described as being performed using the electronic device 101 in the network configuration 100 shown in FIG. 1. However, the process 200 shown in FIG. 2 may be performed using any other suitable device(s) (such as the server 106) and in any other suitable system(s).

As shown in FIG. 2, the electronic device 101 captures an image sequence 212 during capture operation 210. The image sequence 212 includes a number of image frames, three of which are labeled F1, F2, and F3 in FIG. 2. The capture operation 210 could obtain high-resolution color image frames or other image frames captured using one or more see-through color cameras or other imaging sensors 180 of the electronic device 101. The capture operation 210 can obtain any suitable number of image frames. In some cases, the capture operation 210 may obtain image frames at a specified frame rate, such as 30, 60, 90, or 120 frames per second. The image frames may also be obtained from any suitable number of imaging sensors 180, such as from left and right see-through cameras. Further, each image frame can have any suitable size, shape, and resolution and include image data in any suitable domain. As particular examples, each image frame may include RGB image data, YUV image data, or Bayer or other raw image data. In addition, different image frames capturing the same scene could have the same exposure or different exposures.

During capture of the image sequence 212, color changes and/or lighting changes in the scene can occur and can be captured in the image frames. Color changes and lighting changes in the scene can occur, for example, when brightness or colors of an outdoor scene change (such as due to changes in cloud coverage that affect sunlight or moonlight) or when brightness or colors of an indoor scene change (such as due to a light source turning on or off and changing luminance or color hues). As a particular example, the second image frame F2 could have less brightness (less luminance) than the third image frame F3 and could have more brightness than the first image frame F1. In this example, the image frames capture an outdoor scene including an object 214 (namely a tree), but the actual scene being imaged can vary widely.

A color and light matching operation 220 generally operates to perform a registration process using the image sequence 212 in order to determine overlapping areas 222 and 224 between each pair of consecutive image frames in the image sequence 212. An overlapping area generally represents an area where subject matter is the same in both image frames within a pair of consecutive image frames. For example, the first overlapping area 222 could represent the area where the object 214 is located in the second image frame F2 and in the first image frame F1. The second overlapping area 224 could represent the area where the object 214 is located in the third image frame F3 and in the second image frame F2. The color and light matching operation 220 also operates to generate one or more color-matching models, which can be applied to the identified overlapping areas 222 and 224 in order to determine one or more color differences. The color and light matching operation 220 further operates to generate one or more luminance-matching models, which can be applied to the identified overlapping areas 222 and 224 in order to determine one or more luminance differences. In this way, the electronic device 101 can measure a color distance parameter (color difference) and a luminance distance parameter (luminance difference) of neighboring image frames.

If the differences between the neighboring image frames are adequately large (such as above one or more thresholds), a color and brightness model generation operation 230 and a color and light enhancement operation 240 can be performed using the neighboring image frames. The operations 230 and 240 can be used to reduce differences and errors and enhance colors and luminance of the neighboring image frames. These operations 230 and 240 can be used to generate enhanced or improved image frames. If not needed, the operations 230 and 240 could be skipped. Also, in some cases, the color and light matching operation 220 may not identify any overlapping areas 222 and 224 between pairs of consecutive image frames. This may be treated as a camera error or other error, in which case other operations may be performed.

During the model generation operation 230, at least some of the image frames in the image sequence 212 are processed to generate color and brightness models, which can be applied to at least some of the image frames in the image sequence 212 during the enhancement operation 240. Application of the color and brightness models can provide color-smoothing and/or luminance-smoothing of at least some of the image frames. For example, the enhancement operation 240 can reduce color changes and/or luminance changes between consecutive image frames in the image sequence 212. This can help to improve color consistency and luminance consistency in the image sequence 212. In some cases, the enhancement operation 240 can smooth color and lightness changes between neighboring image frames and reduce or minimize color and lightness changes using a global optimization process, helping to make color and lightness more consistent. Example techniques for generating and using color and brightness models are provided below.

Although FIG. 2 illustrates one example of a process 200 for smoothing of a passthrough image sequence 212 for VST XR or other applications, various changes may be made to FIG. 2. For example, various operations or functions in FIG. 2 may be combined, further subdivided, replicated, omitted, or rearranged and additional operations or functions may be added according to particular needs.

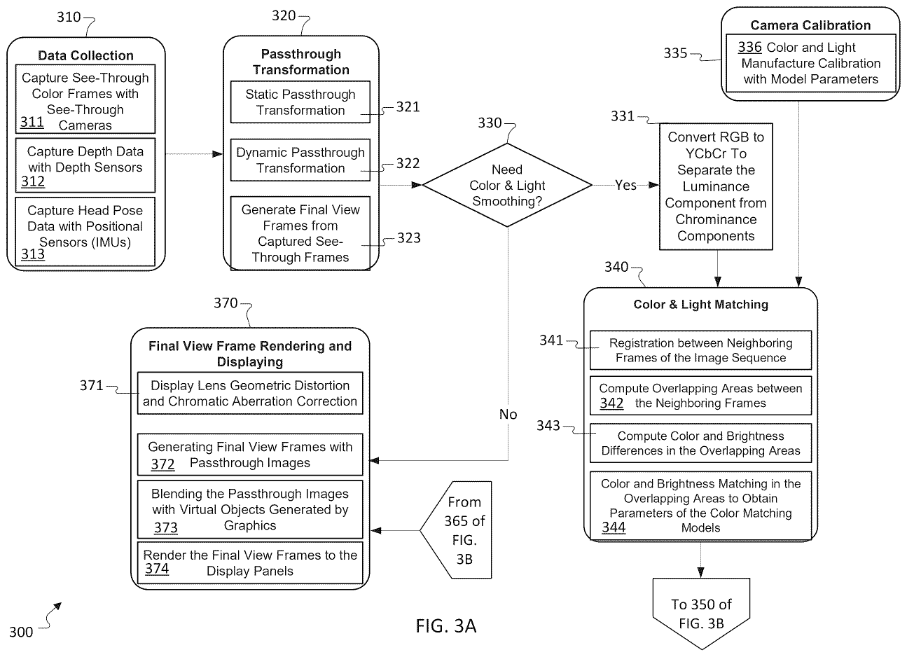

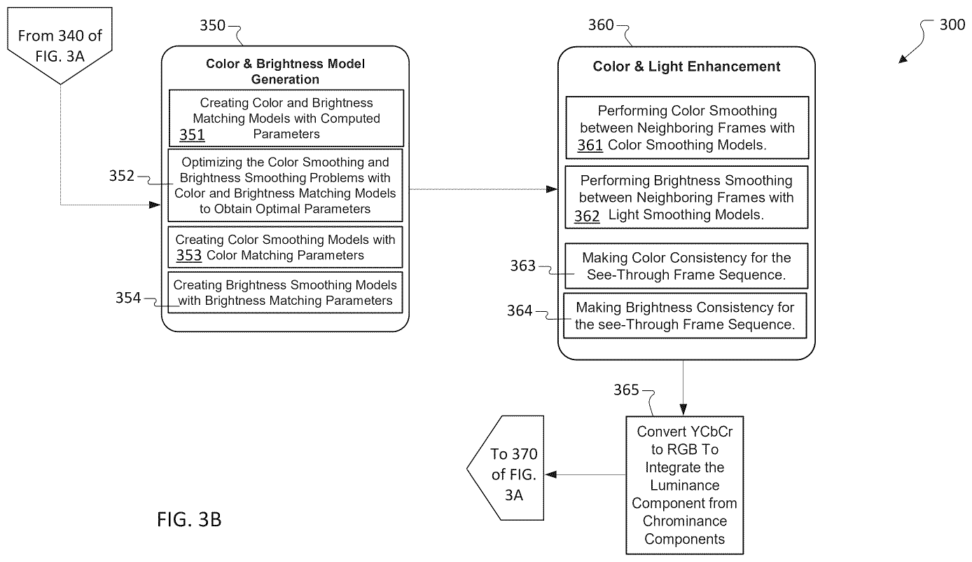

FIGS. 3A and 3B illustrate an example architecture 300 for smoothing of a passthrough image sequence for VST XR or other applications in accordance with this disclosure. For ease of explanation, the architecture 300 shown in FIGS. 3A and 3B is described as being implemented using the electronic device 101 in the network configuration 100 shown in FIG. 1. However, the architecture 300 shown in FIGS. 3A and 3B may be implemented using any other suitable device(s) (such as the server 106) and in any other suitable system(s).

As shown in FIG. 3A, the architecture 300 includes a data collection function 310, which generally operates to obtain image frames and optionally other information for further processing. In some embodiments, the data collection function 310 may be implemented using an image frame capture function 311, a depth data capture function 312, and a head pose data capture function 313. The image frame capture function 311 generally operates to obtain image frames of scenes, such as image frames captured using one or more see-through cameras or other imaging sensors 180 of the electronic device 101. In some cases, each captured image frame may represent an image frame of a scene captured by a forward-facing or other imaging sensor(s) 180 of the electronic device 101.

The depth data capture function 312 generally operates to obtain depth data associated with each image frame. The depth data may be obtained from any suitable source(s), such as from one or more depth sensors like one or more time-of-flight (ToF) sensors, light detection and ranging (LiDAR) sensors, or stereo vision sensors. In some cases, for example, the depth data may include time measurements of light pulses returning to a ToF sensor, distorted light patterns, or RGB images from slightly different angles.

The head pose data capture function 313 generally operates to obtain information related to the pose of the user's head while the electronic device 101 is being used. The head pose information may be obtained from any suitable source(s), such as from one or more positional sensors like at least one IMU. In some cases, the head pose information may be expressed using six degrees of freedom, such as three translation values and three rotation values. The three translation values may identify movement of the user's head along three orthogonal axes, and the three rotation values may identify rotation of the user's head about the three orthogonal axes. Note, however, that the head pose information may have any other suitable form.

A passthrough transformation function 320 generally operates to apply one or more transformations to image frames, such as to transform image data from viewpoints of imaging sensors 180 to viewpoints of a user's eyes. Among other things, this could help to correct for parallax or other errors. In some embodiments, the passthrough transformation function 320 may be implemented using a static passthrough transformation function 321, a dynamic passthrough transformation function 322, and a final view generation function 323.

The static passthrough transformation function 321 generally operates to apply one or more static transformations to image frames. The static transformation(s) may not depend on the contents of the image frames being processed and could be based on the components of the electronic device 101 and/or the configuration of the components of the electronic device 101, which may generally remain constant during use (although some modifications may be permitted). The dynamic passthrough transformation function 322 generally operates to apply one or more dynamic transformations to image frames. The dynamic transformation(s) may depend on the contents of the image frames being processed.

The final view generation function 323 generally operates to create final views of a scene captured in the image frames being processed. For example, the final view generation function 323 may process original or transformed image frames and perform any additional refinements or modifications needed or desired, where the resulting images can represent the final views of the scene. As a particular example, a 3D-to-2D warping function could be used to warp the final views of the scene into 2D images.

A decision function 330 is used to determine whether color and/or light smoothing should be performed. The electronic device 101 may use any suitable criterion or criteria to determine whether color and/or light smoothing should be performed. For example, the electronic device 101 could identify and compare the color and lighting conditions of a current image frame being processed in an image sequence to the color and lighting conditions of at least one preceding image frame in the sequence. As a particular example, the decision function 330 could compare measured color distance and luminance distance parameters of neighboring image frames to appropriate threshold values. If the color and lighting conditions are already generally smooth between the image frames, the architecture 300 can process the image frames using function 370 as described below.

If the color and lighting conditions should be smoothed between the image frames, the architecture 300 can process the image frames using a color space conversion function 331. The color space conversion function 331 generally operates to convert the image frames being processed into a format that includes a separate luminance channel or other separate luminance data. For example, the color space conversion function 331 could convert RGB image frames or other image frames into a YCbCr color space, where Y represents a luminance channel and Cb and Cr represent chrominance channels. Note, however, that other color spaces may be used, such as the YUV color space or the HSV color space. Also note that color space conversion is optional.

In some embodiments, a camera calibration function 335 can be used to generate calibration data 336, and the calibration data 336 can be used to support color and/or luminance smoothing. For example, in some cases, the camera calibration function 335 may be performed during manufacture of the electronic device 101, in which case only the calibration data 336 may be available to the architecture 300. In other cases, the camera calibration function 335 may be performed or initiated by a user of the electronic device 101. The calibration data 336 can represent one or more characteristics of the imaging sensor(s) 180 used to capture image frames, such as one or more extrinsic parameters of each imaging sensor 180. The calibration data 336 could be embedded or otherwise stored on the electronic device 101 (such as by a manufacturer or by a developer using a software development kit), stored in a cloud environment accessible by the electronic device 101, or otherwise made available to the electronic device 101. As described below, the calibration data 336 could allow the electronic device 101 to generate or use predefined color and luminance models.

A color and light matching function 340 generally operates to perform color and light/brightness matching between image frames in the sequence. For example, the color and light matching function 340 could implement the color and light matching operation 220 described above. In some embodiments, the color and light matching function 340 may be implemented using a registration function 341, an overlap identification function 342, a color and brightness differences computation function 343, and a color and brightness matching computation function 344.

The registration function 341 generally operates to modify one or more of the image frames in the sequence in order to generate aligned image frames. For example, the image frames may undergo registration so that common features in different image frames are at the same or substantially the same locations in the aligned image frames. In some embodiments, the registration function 341 may select a reference image frame and modify one or more non-reference image frames so as to be aligned with the reference image frame. In some cases, for instance, the registration function 341 generates a warp or alignment map for each non-reference image frame, where each warp or alignment map includes or is based on one or more motion vectors that identify how the position(s) of one or more specific features in the associated non-reference image frame should be altered in order to be in the position(s) of the same feature(s) in the reference image frame. Among other reasons, alignment may be needed in order to compensate for misalignment caused by the electronic device 101 moving or rotating in between image captures, which causes objects in the image frames to move or rotate slightly (as is common with handheld devices). The registration function 341 may use any suitable technique(s) for image registration. In some embodiments, the aligned image frames can be aligned both geometrically and photometrically. In particular embodiments, the registration function 341 can use global Oriented FAST and Rotated BRIEF (ORB) features and local features from a block search to identify how to align the image frames. Note, however, that this disclosure is not limited to any particular technique(s) for aligning image frames.

The overlap identification function 342 generally operates to identify overlapping areas in neighboring image frames. For example, the overlap identification function 342 can calculate a boundary area or range where points match each other between each pair of neighboring image frames in the sequence. The color and brightness differences computation function 343 generally operates to identify color differences and luminance differences in the identified overlapping areas. For example, the color and brightness differences computation function 343 could identify chrominance differences based on the chrominance channels of the neighboring image frames, and the color and brightness differences computation function 343 could identify luminance differences based on the luminance channels of the neighboring image frames.

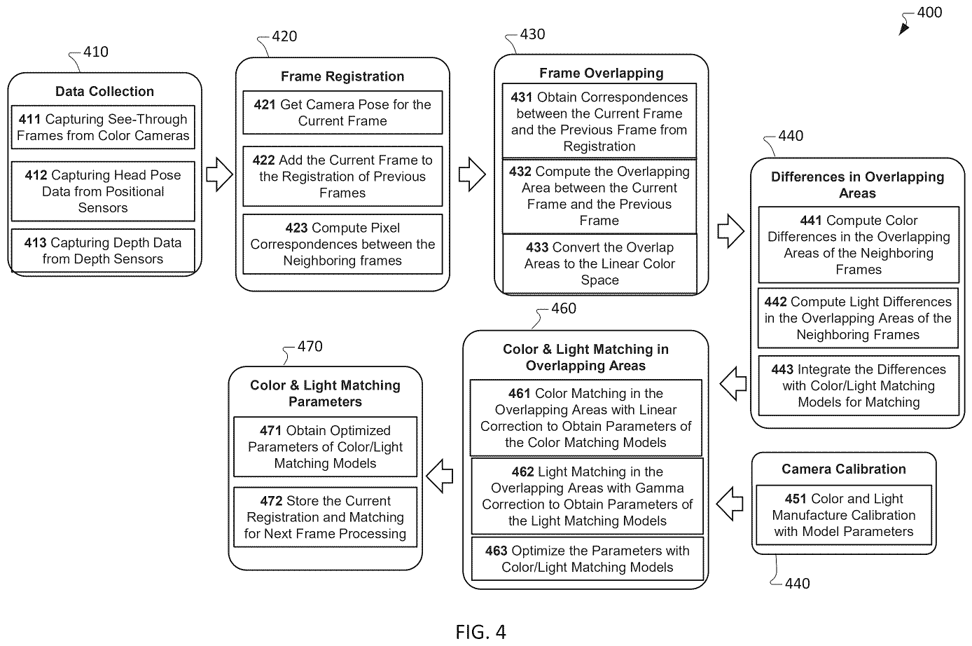

The color and brightness matching computation function 344 generally operates to determine how to perform color matching and light/brightness matching in the identified overlapping areas based on the luminance and color differences. For example, the color and brightness matching computation function 344 can process the luminance and color differences in order to identify parameters of one or more color-matching models and one or more luminance-matching models. One example of how this may occur is shown in FIG. 4, which is described below.

As shown in FIG. 3B, a color and brightness model generation function 350 generally operates to create color-matching and luminance-matching models for use. For example, the color and brightness model generation function 350 could implement the color and brightness model generation operation 230 described above. In some embodiments, the color and brightness model generation function 350 may be implemented using a color and brightness matching model creation function 351, a color and brightness model optimization function 352, a color smoothing model creation function 353, and a brightness smoothing model creation function 354.

The model creation function 351 generally operates to create color and brightness matching models for the image frames being processed. For example, the model creation function 351 may initially generate color and brightness matching models based on the calibration data 336 and subsequently generate color and brightness matching models based on the parameters identified using the color and brightness matching computation function 344. One example of how this may occur is shown in FIG. 4, which is described below.

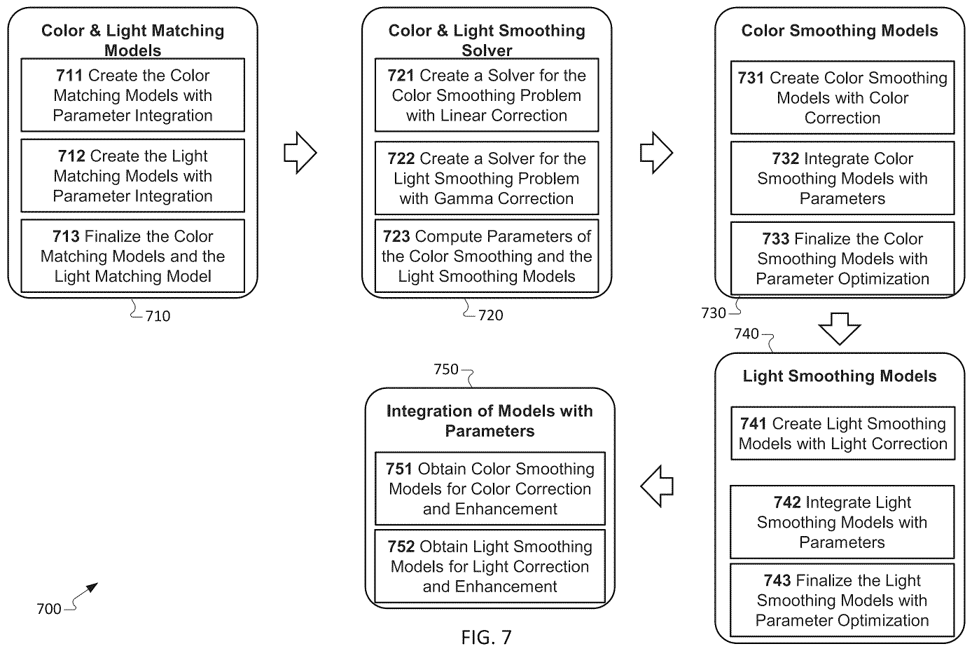

The color and brightness model optimization function 352 generally operates to identify optimal parameters for the color and brightness matching models. For example, the color and brightness model optimization function 352 can optimize color smoothing and brightness smoothing problems with the color and brightness matching models to obtain the optimal parameters. As a particular example, the color and brightness matching models may be defined using systems of equations, and the color and brightness model optimization function 352 could solve the systems of equations by inputting parameters into the models. The color smoothing model creation function 353 and the brightness smoothing model creation function 354 generally operate to create at least one color smoothing model and at least one brightness smoothing model using the optimized parameters of the color and brightness matching models. One example of how this may occur is shown in FIG. 7, which is described below.

A color and light enhancement function 360 generally operates to perform color enhancement and/or luminance enhancement of at least some of the image frames, which can (among other things) transform sudden changes in luminance and/or color in the sequence of image frames into more gradual changes in the sequence of image frames. For example, the color and light enhancement function 360 could implement the color and light enhancement operation 240 described above. In some embodiments, the color and light enhancement function 360 may be implemented using a color smoothing function 361, a brightness smoothing function 362, a color consistency function 363, and a brightness consistency function 364.

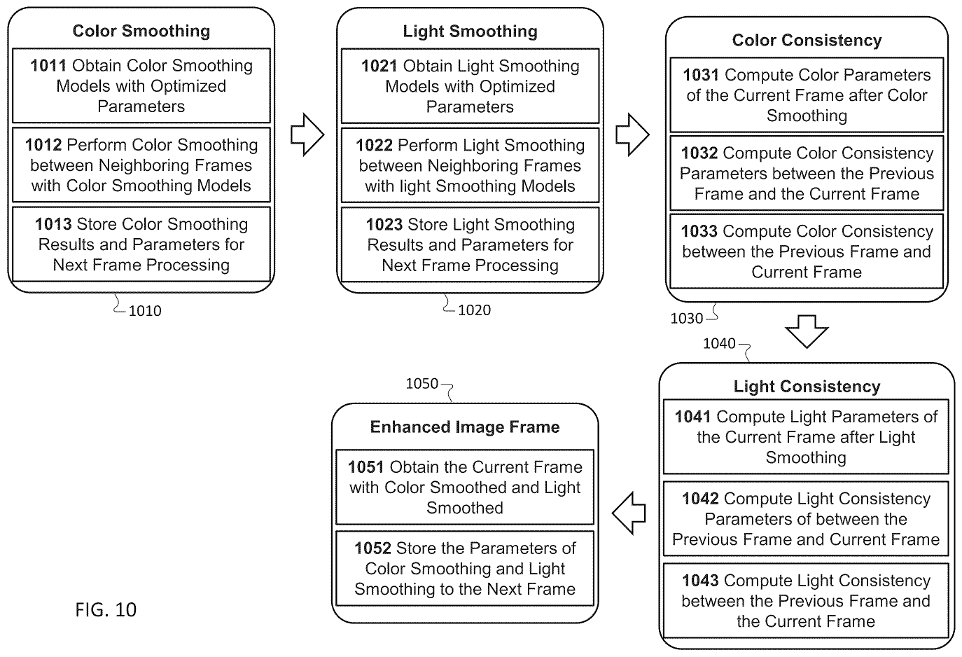

The color smoothing function 361 generally operates to apply the color smoothing model(s) to at least some of the image frames in the sequence in order to smooth color changes between at least some of the image frames. Similarly, the brightness smoothing function 362 generally operates to apply the brightness smoothing model(s) to at least some of the image frames in the sequence in order to smooth lighting changes between at least some of the image frames. The color consistency function 363 and the brightness consistency function 364 generally operate to process the modified image frames as produced by the smoothing functions 361-362 to help improve color consistency and luminance consistency in the image frames. One example of how this may occur is shown in FIG. 10, which is described below.

A color space conversion function 365 generally operates to convert the image frames being processed from a format that includes a separate luminance channel or other separate luminance data into another format (possibly the original format of the image frames). For example, the color space conversion function 365 could convert image frames in the YCbCr, YUV, or HSV color space into RGB image frames. Note, however, that other color spaces may be used. Also note that color space conversion is optional.

A final view frame rendering and display function 370 generally operates to render images that are presented to a user of the electronic device 101. For example, the final view frame rendering and display function 370 can perform final transformations to generate images that appear to have been captured from the viewpoints of the user's eyes, and the final view frame rendering and display function 370 can initiate presentation of the final images to the user. In some embodiments, the final view frame rendering and display function 370 may be implemented using a correction function 371, a final view frame generation function 372, a blending function 373, and a rendering function 374.

The correction function 371 generally operates to perform transformations or other corrections for various issues that can affect rendered and displayed images. For example, the correction function 371 could perform a display geometric distortion calibration (GDC) and chromatic aberration correction (CAC) transformation. For instance, in many VST XR devices, rendered images are presented on one or more display panels (such as one or more displays 160), and rendered images are often viewed by the user through left and right display lenses positioned between the user's eyes and the display panel(s). However, the display lenses may create geometric distortions when displayed images are viewed, and the display lenses may create chromatic aberrations when light passes through the display lenses. The correction function 371 can make adjustments to image frames so that the resulting images pre-compensate for the expected geometric distortions and chromatic aberrations. Thus, the correction function 371 may determine how images should be pre-distorted to compensate for the subsequent geometric distortions and chromatic aberrations created when the images are displayed and viewed through the display lenses. In some cases, the correction function 371 may operate based on a display lens GDC and CAC model, which can mathematically represent the geometric distortions and chromatic aberrations created by the display lenses.

The final view frame generation function 372 can generate final view image frames based on the image frames provided by the correction function 371. For example, the final view frame generation function 372 could perform any additional refinements or modifications needed or desired, and the resulting images can represent the final views of the scene. For example, a 3D-to-2D warping can be used to warp the final views of the scene into 2D images. The blending function 373 may optionally be used to blend one or more virtual objects or other virtual information into the final view frames, such as to overlay one or more virtual objects within the scene being viewed by the user. Any suitable virtual information or other objects may be presented here. The rendering function 374 generally operates to render the images into final form, such as by rendering the images into a form suitable for transmission to at least one display 160. The rendering function 374 can also initiate display of the rendered images, such as by providing the rendered images to one or more displays 160.

Although FIGS. 3A and 3B illustrate one example of an architecture 300 for smoothing of a passthrough image sequence for VST XR or other applications, various changes may be made to FIGS. 3A and 3B. For example, various operations or functions in FIGS. 3A and 3B may be combined, further subdivided, replicated, omitted, or rearranged and additional operations or functions may be added according to particular needs. As a particular example, the color space conversion operations may not be needed, and color smoothing could be performed in each individual color channel of the image frames. As another particular example, color and light matching and enhancement could be performed before passthrough transformation.

FIG. 4 illustrates an example process 400 for color and light matching between image frames in accordance with this disclosure. The process 400 may, for example, be performed as part of the color and light matching function 340 described above. For ease of explanation, the process 400 shown in FIG. 4 is described as being performed using the electronic device 101 in the network configuration 100 shown in FIG. 1. However, the process 400 shown in FIG. 4 may be performed using any other suitable device(s) (such as the server 106) and in any other suitable system(s).

As shown in FIG. 4, the process 400 includes a data collection function 410, which may include an image frame capture function 411, a depth data capture function 412, and a head pose data capture function 413. These functions 410-413 may be the same as or similar to corresponding functions 310-313 described above.

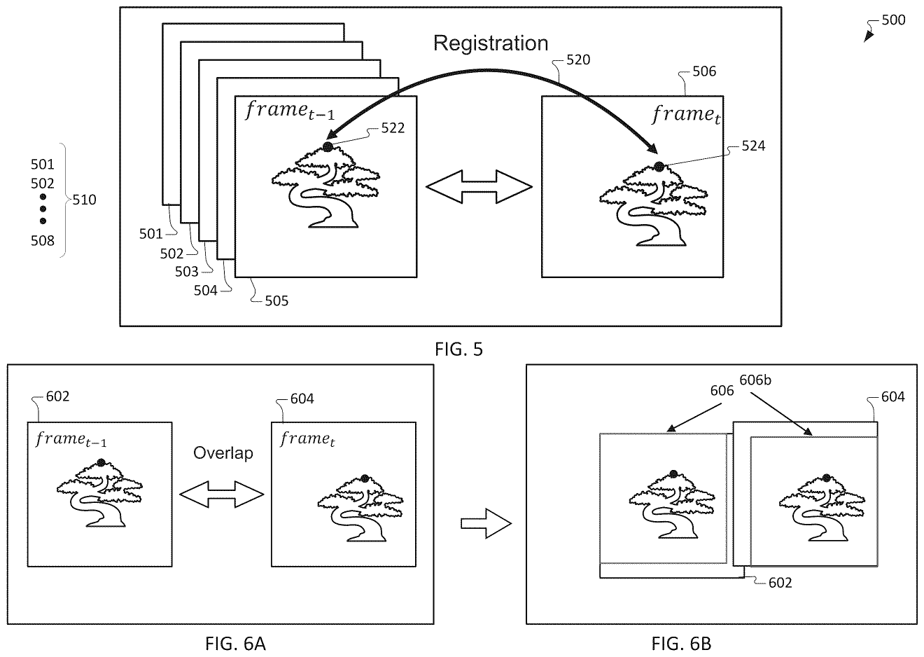

A frame registration function 420 could be used to implement the registration function 341 described above. In some embodiments, the frame registration function 420 may be implemented using a camera pose identification function 421, a frame addition function 422, and a pixel correspondence calculation function 423. The camera pose identification function 421 generally operates to identify a camera pose associated with a current image frame being processed in a sequence. For example, the camera pose identification function 421 could identify a current head pose of the user of the electronic device 101. The frame addition function 422 generally operates to add the current image frame into the registration of one or more previous image frames. For instance, the frame addition function 422 can align the current image frame with the previous image frames in the sequence. The pixel correspondence calculation function 423 generally operates to identify pixels that correspond to one another between neighboring image frames. One example of this type of frame registration procedure is shown in FIG. 5, which is described below.

A frame overlapping function 430 could be used to implement the overlap identification function 342 described above. In some embodiments, the frame overlapping function 430 may be implemented using a frame correspondence identification function 431, an overlapping area computation function 432, and an overlapping area conversion function 433. The frame correspondence identification function 431 generally operates to obtain correspondences (such as pixel correspondences) between the current image frame being processed and the previous image frame(s) from the frame registration function 420. The overlapping area computation function 432 generally operates to use the correspondences to identify one or more overlapping areas between the current image frame and the previous image frame(s). The overlapping area conversion function 433 generally operates to convert the one or more overlapping areas into a suitable color space, such as a linear color space, for color processing. One example of this type of frame overlapping procedure is shown in FIGS. 6A and 6B, which are described below.

An overlapping area differences function 440 could be used to implement the color and brightness differences computation function 343 described above. In some embodiments, the overlapping area differences function 440 may be implemented using a color differences computation function 441, a light differences computation function 442, and an integration function 443. The color differences computation function 441 generally operates to identify color or chrominance differences between neighboring image frames, and the light differences computation function 442 generally operates to identify light or brightness differences between the neighboring image frames. In some cases, this can be done for different channels of image data (such as luminance and chrominance color channels). The integration function 443 generally operates to integrate or combine the color and light differences between the neighboring image frames with color-matching and light-matching models. For example, integration curves may be created to smooth transitions from a first overlapping area (such as between a first frame and a second frame) to a latest overlapping area (such as between a current frame and the preceding frame).

A camera calibration function 450 could be the same as or similar to the camera calibration function 335 described above. The camera calibration function 450 can be used to generate calibration data 451, which could be the same as or similar to the calibration data 336 described above.

A color and light matching function 460 and a color and light matching parameters function 470 could be used to implement the color and brightness matching computation function 344 described above. In some embodiments, the color and light matching function 460 may be implemented using a color matching function 461, a light matching function 462, and a parameter optimization function 463.

The color matching function 461 generally operates to determine how color matching between overlapping areas in image frames should be performed. For example, the color matching function 461 could determine how color matching should be performed using linear correction in order to more closely match the colors in the overlapping areas of the image frames. This can lead to the generation of parameters for one or more color matching models. In some cases, the linear correction here could be defined as follows.

$${a}_{t - 1} {C}_{t - 1} ( p ) + {b}_{t - 1} = {a}_{t} {C}_{t} ( p ) + {b}_{t}$$

Here, Cₜ₋₁(p) represents the chrominance of the preceding image frame Iₜ₋₁, and Cₜ(p) represents the chrominance of the current image frame Iₜ. Also, (aₜ₋₁, bₜ₋₁) and (aₜ, bₜ) represent parameters for color matching.

The light matching function 462 generally operates to determine how brightness matching between overlapping areas in image frames should be performed. For instance, the light matching function 462 could determine how brightness matching should be performed using gamma correction in order to more closely match the luminances in the overlapping areas of the image frames. This can lead to the generation of parameters for one or more light matching models. In some cases, the gamma correction here could be defined as follows.

$${α}_{t - 1} {L}_{t - 1}^{{γ}_{t - 1}} ( p ) + {β}_{t - 1} = {α}_{t} {L}_{t}^{{γ}_{t}} ( p ) + {β}_{t}$$

Here, Lₜ₋₁(p) represents the luminance of the preceding image frame Iₜ₋₁, and Lₜ(p) represents the luminance of the current image frame Iₜ. Also, (αₜ₋₁, βₜ₋₁, γₜ₋₁) and (αt, βₜ, γₜ) represent parameters for light matching.

The parameter optimization function 463 generally operates to identify optimal parameters for the color and light matching models. For example, the parameter optimization function 463 can optimize a color matching problem to obtain finalized parameters (aₜ₋₁, bₜ₋₁) and (aₜ, bₜ) for the color matching model(s). The parameter optimization function 463 can also optimize a light matching problem to obtain finalized parameters (aₜ₋₁, βₜ₋₁, γₜ₋₁) and (αₜ, βₜ, γₜ) for the light matching model(s).

In some embodiments, the color and light matching parameters function 470 may be implemented using optimized parameter obtaining function 471 and an optimized parameter storage function 472. The optimized parameter obtaining function 471 generally operates to obtain the optimized parameters identified by the color and light matching function 460. The optimized parameter storage function 472 generally operates to store the optimized parameters and the registered image frames for use during processing of the next image frame, such as in a frame registry or other data structure in the memory 130.

FIG. 5 illustrates an example registration 500 of image frames in accordance with this disclosure. More specifically, FIG. 5 illustrates an example registration 500 involving image frames 501-508 within a sequence 510 of image frames. In this example, the registration 500 is between an image frame 506 (frameₜ) and the previous frame 505 (frameₜ₋₁). Via suitable image registration processing, a pixel correspondence 520 can be identified between two pixels 522 and 524 captured in the image frames 505 and 506. The two pixels 522 and 524 here can represent the same point within the scene, but movement (such as movement of the electronic device 101) can cause those pixels to appear at different locations within different image frames. Registration to identify any number of pixel correspondences can be performed in order to support registration of the various image frames in the sequence 510. In some cases, registrations of prior image frames (such as image frames 501-505) could be used to inform or otherwise support registration of subsequent image frames (such as image frames 505-508).

This type of registration may be useful or desirable due to various factors, such as head pose changes of a user or other changes to the position of the electronic device 101 relative to the scene being viewed. For example, if the user's head pose changes from time t−1 for the frame 505 to the time t of the frame 506, the electronic device 101 can perform a transformation between the two consecutive frames 505 and 506. This transformation could be implemented using the passthrough transformation function 320 of FIG. 3 and could be based on captured head pose data.

FIGS. 6A and 6B illustrate an example overlapping 600 of image frames 602 and 604 in accordance with this disclosure. The image frames 602 and 604 may represent a consecutive pair of images in a sequence. As can be seen in this example, the image frames 602 and 604 are captured at different times, and movement causes the image frames 602 and 604 to capture different portions of the scene. Using pixel correspondences or other correspondences, overlapping areas 606a-606b can be identified, where the overlapping areas 606a-606b represent portions of the image frames 602 and 604 that capture a common portion of the scene. Remaining areas of the image frames 602 and 604 outside the overlapping areas 606a-606b may not exhibit pixel correspondences and therefore do not overlap. These remaining areas can therefore be referred to as non-overlapping areas.

Although FIGS. 4 through 6B illustrate one example of a process 400 for color and light matching between image frames and related details, various changes may be made to FIGS. 4 through 6B. For example, various operations or functions in FIG. 4 may be combined, further subdivided, replicated, omitted, or rearranged and additional operations or functions may be added according to particular needs. Also, the pixel correspondences in FIG. 5 and overlapping areas in FIGS. 6A and 6B are examples only and can easily vary depending (among other things) on the scene being imaged and movement of the electronic device 101.

FIG. 7 illustrates an example process 700 for generating smoothing models in accordance with this disclosure. The process 700 may, for example, be performed as part of the color and brightness model generation function 350 described above. For ease of explanation, the process 700 shown in FIG. 7 is described as being performed using the electronic device 101 in the network configuration 100 shown in FIG. 1. However, the process 700 shown in FIG. 7 may be performed using any other suitable device(s) (such as the server 106) and in any other suitable system(s).

As shown in FIG. 7, a color and lightness models generation function 710 could be used to implement the color and brightness matching model creation function 351 described above. In some embodiments, the color and lightness models generation function 710 may be implemented using a color matching model creation function 711, a light matching model creation function 712, and a model finalization function 713.

The color matching model creation function 711 generally operates to create color matching models by integrating the parameters identified by the color and light matching function 340. For example, color errors in color matching between adjacent image frames could be expressed as follows.

$$\{ \begin{matrix}{e}_{c 21} = {a}_{2} {C}_{21} ( p ) + {b}_{2} - ( {a}_{1} {C}_{12} ( p ) + {b}_{1} ) \\ {e}_{c 32} = {a}_{3} {C}_{32} ( p ) + {b}_{3} - ( {a}_{2} {C}_{23} ( p ) + {b}_{2} ) \\ … \\ {e}_{c i i - 1} = {a}_{i} {C}_{i i - 1} ( p ) + {b}_{i} - ( {a}_{i - 1} {C}_{i - 1 i} ( p ) + {b}_{i - 1} )\end{matrix}$$

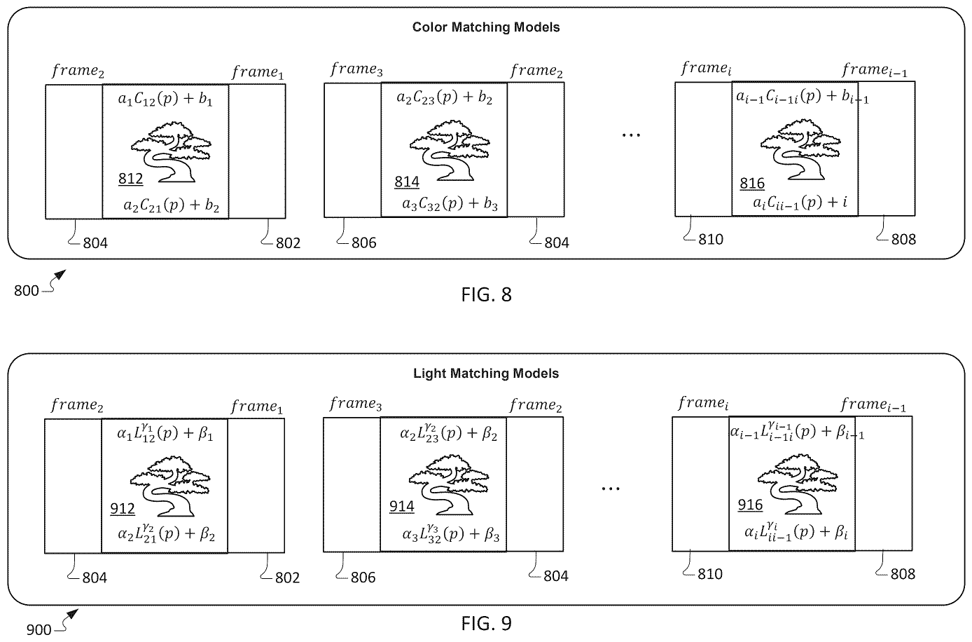

Here, Cᵢᵢ₋₁ represents color in image frame i in an overlapping area between the image frame i and a preceding image frame i−1. Also, Cᵢ₋₁ᵢ represents color in the preceding image frame i−1 in the overlapping area between the image frame i and the preceding image frame i−1. A color matching model can be defined that identifies these errors or differences in colors between the image frames. One example of this is shown in FIG. 8, which is described below.

Similarly, the light matching model creation function 712 generally operates to create light matching models by integrating the parameters identified by the color and light matching function 340. For example, light errors in light matching between adjacent image frames could be expressed as follows.

$$\{ \begin{matrix}{e}_{l 21} = {α}_{2} {L}_{21}^{{γ}_{2}} + {β}_{2} - ( {α}_{1} {L}_{12}^{{γ}_{2}} + {β}_{1} ) \\ {e}_{l 32} = {α}_{3} {L}_{32}^{{γ}_{3}} + {β}_{3} - ( {α}_{2} {L}_{23}^{{γ}_{2}} + {β}_{2} ) \\ … \\ {e}_{l i i - 1} = {α}_{i} {L}_{i i - 1}^{{γ}_{i}} + {β}_{i} - ( {α}_{i - 1} {L}_{i - 1 i}^{{γ}_{i - 1}} + {β}_{i - 1} )\end{matrix}$$

Here, Lᵢᵢ₋₁ represents light in image frame i in an overlapping area between the image frame i and a preceding image frame i−1. Also, Lᵢ₋₁ᵢ represents light in the preceding image frame i−1 in the overlapping area between the image frame i and the preceding image frame i−1. A light matching model can be defined that identifies these errors or differences in luminances between the image frames. One example of this is shown in FIG. 9, which is described below.

The model finalization function 713 generally operates to create finalized color matching and light matching models based on the models from the creation functions 711-712. For example, the model finalization function 713 may adjust the previously-created models in order to provide any additional color or light adjustments as needed or desired.

A color and light smoothing solver function 720 could be used to implement the color and brightness model optimization function 352 described above. In some embodiments, the color and light smoothing solver function 720 may be implemented using a color solver creation function 721, a light solver creation function 722, and a parameter computation function 723.

The color solver creation function 721 generally operates to create a solver for a color smoothing problem. For example, the solver may attempt to use linear correction in order to smooth colors between adjacent image frames. As a particular example, the color smoothing problem could be expressed as follows.

$${min}_{{a}_{i} , {b}_{i}} {e}_{c} = {min}_{{a}_{i} , {b}_{i}} ( {e}_{c 21}^{2} + {e}_{c 32}^{2} + … + {e}_{c i i - 1}^{2} ) .$$

A linear solver can therefore be defined, where the linear solver can be used to solve this minimization problem and obtain parameters (aᵢ, bᵢ) for a current image frame i. Similarly, the light solver creation function 722 generally operates to create a solver for a light smoothing problem. For instance, the solver may attempt to use gamma correction in order to smooth luminances between adjacent image frames. As a particular example, the light smoothing problem could be expressed as follows.

$${min}_{{α}_{i} , {β}_{i} {γ}_{i}} {e}_{l} = {min}_{{α}_{i} , {β}_{i} , {γ}_{i}} ( {e}_{l 21}^{2} + {e}_{l 32}^{2} + … + {e}_{l i i - 1}^{2} )$$

A solver can therefore be defined, where the solver can be used to solve this minimization problem and obtain parameters (αᵢ, βᵢ, γᵢ) for the current image frame i. The parameter computation function 723 generally operates to identify parameters for color and light smoothing models. For example, the parameter computation function 723 can use the parameters (aᵢ, bᵢ) identified above for one or more color-smoothing models and use the parameters (αᵢ, βᵢ, γᵢ) identified above for one or more light-smoothing models.

A color smoothing model creation function 730 could be used to implement the color smoothing model creation function 353 described above. In some embodiments, the color smoothing model creation function 730 may be implemented using a model creation function 731, a model integration function 732, and a model finalization function 733.

The model creation function 731 generally operates to create a color smoothing model. There may be various types of mathematical models that define how color smoothing can occur, such as based on different interpolation or other calculations. The model creation function 731 can create an appropriate color smoothing model or use a predefined color smoothing model. The model integration function 732 generally operates to integrate the parameters from the color and light smoothing solver function 720 into the generated color smoothing model. For instance, the model integration function 732 could integrate the parameters (aᵢ, bᵢ) identified above into the color smoothing model. The model finalization function 733 generally operates to finalize the color smoothing model, such as by performing parameter optimization.

A light smoothing model creation function 740 could be used to implement the brightness smoothing model creation function 354 described above. In some embodiments, the light smoothing model creation function 740 may be implemented using a model creation function 741, a model integration function 742, and a model finalization function 743.

The model creation function 741 generally operates to create a light smoothing model. Again, there may be various types of mathematical models that define how light smoothing can occur, such as based on different interpolation or other calculations. The model creation function 741 can create an appropriate light smoothing model or use a predefined light smoothing model. The model integration function 742 generally operates to integrate the parameters from the color and light smoothing solver function 720 into the generated light smoothing model. For instance, the model integration function 742 could integrate the parameters (αᵢ, βᵢ, γᵢ) identified above into the light smoothing model. The model finalization function 743 generally operates to finalize the light smoothing model, such as by performing parameter optimization.

An integration function 750 generally operates to make the models available for further use. For example, the integration function 750 may include a color model obtaining function 751, which can obtain a finalized color smoothing model for one or more image frames being processed. The integration function 750 may also include a light model obtaining function 752, which can obtain a finalized light smoothing model for one or more image frames being processed. The integration function 750 can make these finalized models available for further use, such as by making the models available to the color and light enhancement function 360.

FIG. 8 illustrates an example color matching 800 between image frames using color matching models in accordance with this disclosure. More specifically, FIG. 8 illustrates an example color matching 800 involving image frames 802-810 within a sequence of image frames. In this example, color matching in an overlapping area of the image frames 802-804 is used to define a color matching model 812. Color matching in an overlapping area of the image frames 804-806 is used to define a color matching model 814. Color matching in an overlapping area of the image frames 808-810 is used to define a color matching model 816. In this example, the color matching model 812 can include or be associated with a model of the image frame 802 defined as a₁C₁₂(p)+b₁ and a model of the image frame 804 defined as a₂C₂₁(p)+b₂. Differences between these two models can be denoted a color error e_{c21} (as determined by the color matching model creation function 711). Similar models and errors can be associated with the other color matching models 814 and 816.

FIG. 9 illustrates an example luminance matching 900 between image frames using light matching models in accordance with this disclosure. More specifically, FIG. 9 illustrates an example luminance matching 900 involving the image frames 802-810 within the sequence of image frames. In this example, light matching in an overlapping area of the image frames 802-804 is used to define a light matching model 912. Light matching in an overlapping area of the image frames 804-806 is used to define a light matching model 914. Light matching in an overlapping area of the image frames 908-910 is used to define a light matching model 916. In this example, the light matching model 912 can include or be associated with a model of the image frame 802 defined as

$${α}_{1} {L}_{12}^{{γ}_{1}} ( p ) + {β}_{1}$$

and a model of the image frame 804 defined as

$${α}_{2} {L}_{21}^{{γ}_{2}} ( p ) + {β}_{2} .$$

Differences between these two models can be denoted a light error eₗ₂₁ (as determined by the light matching model creation function 712). Similar models and errors can be associated with the other light matching models 914 and 916.

Although FIGS. 7 through 9 illustrates one example of a process 700 for generating smoothing models and related details, various changes may be made to FIGS. 7 through 9. For example, various operations or functions in FIG. 7 may be combined, further subdivided, replicated, omitted, or rearranged and additional operations or functions may be added according to particular needs. Also, the color matching in FIG. 8 and the light matching in FIG. 9 are examples only and can easily vary depending (among other things) on the scene being imaged and movement of the electronic device 101.

FIG. 10 illustrates an example process 1000 for color and luminance enhancement of image frames in accordance with this disclosure. The process 1000 may, for example, be performed as part of the color and light enhancement function 360 described above. For ease of explanation, the process 1000 shown in FIG. 10 is described as being performed using the electronic device 101 in the network configuration 100 shown in FIG. 1. However, the process 1000 shown in FIG. 10 may be performed using any other suitable device(s) (such as the server 106) and in any other suitable system(s).

As shown in FIG. 10, a color smoothing function 1010 could be used to implement the color smoothing function 361 described above. In some embodiments, the color smoothing function 1010 may be implemented using a model obtaining function 1011, a model application function 1012, and a result storage function 1013.

The model obtaining function 1011 can obtain a color smoothing model for a current image frame, such as by obtaining a color smoothing model generated by the color and brightness model generation function 350. The model application function 1012 applies the color smoothing model to the current image frame. For instance, suppose the current image frame is denoted as frame; and that the previous image frames are denoted as frameᵢ₋₁, frameᵢ₋₂, . . . , frame₁ (which have already been processed with color smoothing). This condition can be expressed as follows.

$$\{ \begin{matrix}{C}_{1}^{′} ( p ) = {a}_{1} {C}_{1} ( p ) + {b}_{1} \\ {C}_{2}^{′} ( p ) = {a}_{2} {C}_{2} ( p ) + {b}_{2} \\ … \\ {C}_{i - 1}^{′} = {a}_{i - 1} {C}_{i - 1} ( p ) + {b}_{i - 1}\end{matrix}$$

### Here,

$${C}_{1}^{′} ( p ) , {C}_{2}^{′} ( p ) , … , {C}_{i - 1}^{′} ( p )$$

represent the earlier image frames' colors after color smoothing. Parameters of color smoothing for the current image frame frameᵢ could be determined by solving an optimization problem, such as the following optimization problem.

$${min}_{( {a}_{i} , {b}_{i} )} ( {( {C}_{2}^{′} ( p ) - {C}_{1}^{′} ( p ) )}^{2} + {( {C}_{3}^{′} ( p ) - {C}_{2}^{′} ( p ) )}^{2} + … + {( {C}_{i - 1}^{′} ( p ) - {C}_{i - 2}^{′} ( p ) )}^{2} + {( {a}_{i} {C}_{i} ( p ) + {b}_{i} - {a}_{i - 1} {C}_{i - 1} ( p ) - {b}_{i - 1} )}^{2} )$$

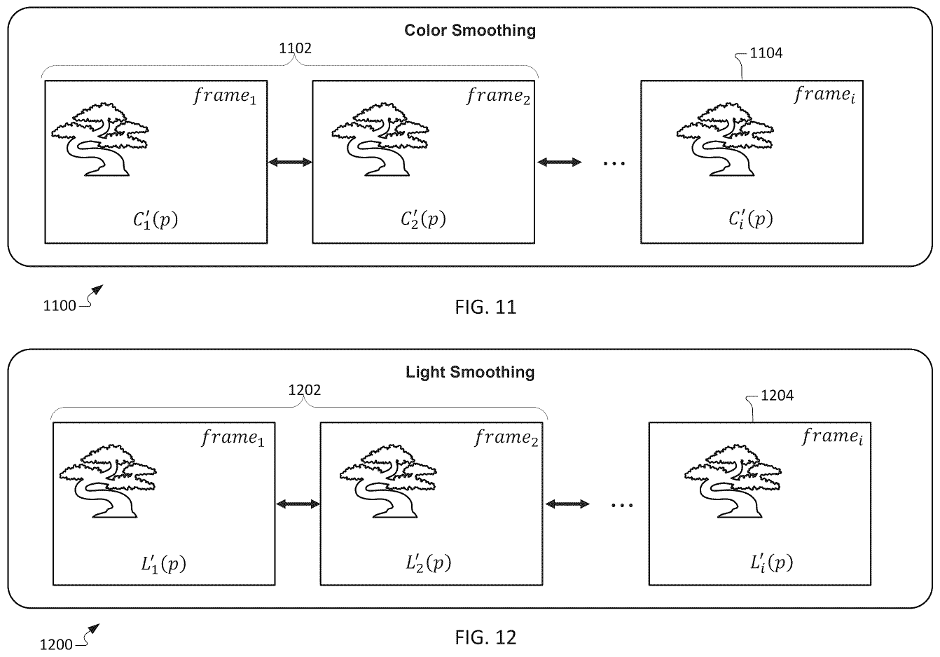

Here, (aᵢ, bᵢ) represent the parameters of color smoothing for the current image frame frameᵢ, which can be applied by the model application function 1012. The result storage function 1013 can store the smoothing results and the model parameters for use during color smoothing of the next image frame, such as in a frame registry or other data structure in the memory 130. One example of color smoothing is shown in FIG. 11, which is described below.

A light smoothing function 1020 could be used to implement the brightness smoothing function 362 described above. In some embodiments, the light smoothing function 1020 may be implemented using a model obtaining function 1021, a model application function 1022, and a result storage function 1023.

The model obtaining function 1021 can obtain a light smoothing model for a current image frame, such as by obtaining a light smoothing model generated by the color and brightness model generation function 350. The model application function 1012 applies the light smoothing model to the current image frame. Again, suppose the current image frame is denoted as frame; and that the previous image frames are denoted as frameᵢ₋₁, frameᵢ₋₂, . . . , frame₁ (which have already been processed with light smoothing). This condition can be expressed as follows.

$$\{ \begin{matrix}{L}_{1}^{′} ( p ) = {α}_{1} {L}_{1}^{{γ}_{1}} ( p ) + {β}_{1} \\ {L}_{2}^{′} ( p ) = {α}_{2} {L}_{2}^{{γ}_{2}} ( p ) + {β}_{2} \\ … \\ {L}_{i - 1}^{′} ( p ) = {α}_{i - 1} {L}_{i - 1}^{{γ}_{i - 1}} ( p ) + {β}_{i - 1}\end{matrix}$$

### Here,

$${L}_{1}^{′} ( p ) , {L}_{2}^{′} ( p ) , … , {L}_{i - 1}^{′} ( p )$$

represent the earlier image frames' luminances after light smoothing. Parameters of light smoothing for the current image frame frameᵢ could be determined by solving an optimization problem, such as the following optimization problem.

$${min}_{( {α}_{i} , {β}_{i} , {γ}_{i} )} ( {( {L}_{2}^{′} ( p ) - {L}_{1}^{′} ( p ) )}^{2} + {( {L}_{3}^{′} ( p ) - {L}_{2}^{′} ( p ) )}^{2} + … + {( {L}_{i - 1}^{′} ( p ) - {L}_{i - 2}^{′} ( p ) )}^{2} + {( {α}_{i} {L}_{i}^{{γ}_{i}} ( p ) + {β}_{i} - {α}_{i - 1} {L}_{i - 1}^{{γ}_{i - 1}} ( p ) - {β}_{i - 1} )}^{2} )$$

Here, (αᵢ, βᵢ, γᵢ) represent the parameters of light smoothing for the current image frame frameᵢ, which can be applied by the model application function 1022. The result storage function 1023 can store the smoothing results and the model parameters for use during light smoothing of the next image frame, such as in a frame registry or other data structure in the memory 130. One example of light smoothing is shown in FIG. 12, which is described below.

A color consistency function 1030 could be used to implement the color consistency function 363 described above. In some embodiments, the color consistency function 1030 may be implemented using a color parameter computation function 1031, a color consistency parameter computation function 1032, and a color consistency computation function 1033. The color parameter computation function 1031 generally operates to determine one or more color parameters of the current image frame after color smoothing. The one or more color parameters represent any suitable values based on the colors in the current image frame after color smoothing. The color consistency parameter computation function 1032 generally operates to determine one or more color consistency parameters between the previous image frame(s) and the current image frame, which can be based on the identified color parameter(s) of the current image frame after color smoothing and the previous image frame(s). The color consistency computation function 1033 generally operates to determine the color consistency between the previous image frame(s) and the current image frame, which can be based on the color consistency parameter(s).

A light consistency function 1040 could be used to implement the brightness consistency function 364 described above. In some embodiments, the light consistency function 1040 may be implemented using a light parameter computation function 1041, a light consistency parameter computation function 1042, and a light consistency computation function 1043. The light parameter computation function 1041 generally operates to determine one or more light parameters of the current image frame after light smoothing. The one or more light parameters represent any suitable values based on the luminances in the current image frame after light smoothing. The light consistency parameter computation function 1042 generally operates to determine one or more light consistency parameters between the previous image frame(s) and the current image frame, which can be based on the identified light parameter(s) of the current image frame after light smoothing and the previous image frame(s). The light consistency computation function 1043 generally operates to determine the light consistency between the previous image frame(s) and the current image frame, which can be based on the light consistency parameter(s).

An enhanced image frame generation function 1050 generally operates to obtain an enhanced image created by color and light smoothing. For example, the enhanced image frame generation function 1050 may include an image frame obtaining function 1051, which can obtain an enhanced image frame produced by the earlier functions 1010-1040. The enhanced image frame generation function 1050 may also include a storage function 1052, which can store the parameters of the color and light smoothing models for use during processing of the next image frame.

FIG. 11 illustrates an example color smoothing 1100 between image frames in accordance with this disclosure. As shown in FIG. 11, color smoothing has been applied to one or more previous image frames 1102, and color smoothing is now being applied to a current image frame 1104. The color smoothing applied to the current image frame 1104 can be performed based on the color-smoothed previous image frames 1102. This helps to provide more consistency in colors across the sequence of image frames.

FIG. 12 illustrates an example luminance smoothing 1200 between image frames in accordance with this disclosure. As shown in FIG. 12, light smoothing has been applied to one or more previous image frames 1202, and light smoothing is now being applied to a current image frame 1204. The light smoothing applied to the current image frame 1204 can be performed based on the light-smoothed previous image frames 1202. This helps to provide more consistency in luminances across the sequence of image frames.

Although FIGS. 10 through 12 illustrates one example of a process 1000 for color and luminance enhancement of image frames and related details, various changes may be made to FIGS. 10 through 12. For example, various operations or functions in FIG. 10 may be combined, further subdivided, replicated, omitted, or rearranged and additional operations or functions may be added according to particular needs. Also, the color and light smoothing in FIGS. 11 and 12 are examples only and can easily vary depending (among other things) on the scene being imaged and movement of the electronic device 101.

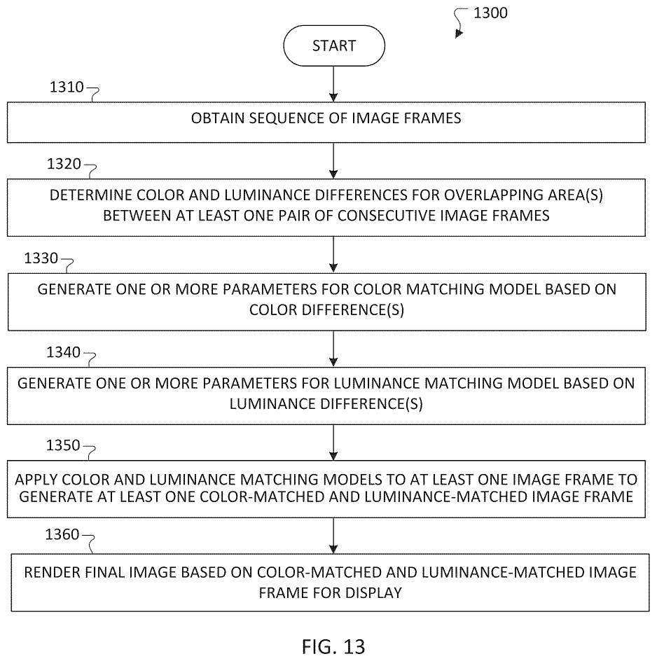

FIG. 13 illustrates an example method 1300 for smoothing of passthrough frame sequences in VST XR or other applications in accordance with this disclosure. For ease of explanation, the method 1300 shown in FIG. 13 is described as being performed using the electronic device 101 in the network configuration 100 shown in FIG. 1. However, the method 1300 shown in FIG. 13 may be performed using any other suitable device(s) (such as the server 106) and in any other suitable system(s).

As shown in FIG. 13, a sequence of image frames is obtained at step 1310. This may include, for example, the processor 120 of the electronic device 101 performing the capture operation 210 or the data collection function 310 to obtain an image sequence 212. The image frames in the sequence may be obtained from any suitable source(s), such as when captured using at least one imaging sensor 180 of the electronic device 101.

One or more color differences and one or more luminance differences are determined for each of one or more overlapping areas between at least one pair of consecutive image frames in the sequence at step 1320. This may include, for example, the processor 120 of the electronic device 101 performing the color and light matching operation 220 or the color and light matching function 340 to identify overlapping areas between consecutive image frames. This may also include the processor 120 of the electronic device 101 performing the color and light matching operation 220 or the color and light matching function 340 to identify color differences and light differences in these overlapping areas.

One or more parameters for a color matching model are generated based on the one or more color differences at step 1330, and one or more parameters for a luminance matching model are generated based on the one or more luminance differences at step 1340. This may include, for example, the processor 120 of the electronic device 101 performing the color and brightness model generation operation 230 or the color and brightness model generation function 350 to generate color and brightness smoothing models.

The color matching model and the luminance matching model are applied to at least one of the image frames to generate at least one color-matched and luminance-matched image frame at step 1350. This may include, for example, the processor 120 of the electronic device 101 performing the color and light enhancement operation 240 or the color and light enhancement function 360 to adjust colors and luminances in one or more of the image frames based on the color and brightness smoothing models.

The color-matched and luminance-matched image frame(s) may be used in any suitable manner. For example, the color-matched and luminance-matched image frame(s) may be used to render at least one final image for display at step 1360. This may include, for example, the processor 120 of the electronic device 101 performing the final view frame rendering and display function 370 to generate one or more final images, which can be displayed on one or more displays 160 of the electronic device 101.

Although FIG. 13 illustrates one example of a method 1300 for smoothing of passthrough frame sequences in VST XR or other applications, various changes may be made to FIG. 13. For example, while shown as a series of steps, various steps in FIG. 13 could overlap, occur in parallel, occur in a different order, or occur any number of times (including zero times). As a particular example, steps 1320-1360 may be performed for each image frame after the first image frame in the obtained sequence.

It should be noted that the functions shown in or described with respect to the figures can be implemented in an electronic device 101, 102, 104, server 106, or other device(s) in any suitable manner. For example, in some embodiments, at least some of the functions shown in or described with respect to the figures can be implemented or supported using one or more software applications or other software instructions that are executed by the processor 120 of the electronic device 101, 102, 104, server 106, or other device(s). In other embodiments, at least some of the functions shown in or described with respect to the figures can be implemented or supported using dedicated hardware components. In general, the functions shown in or described with respect to the figures can be performed using any suitable hardware or any suitable combination of hardware and software/firmware instructions. Also, the functions shown in or described with respect to the figures can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. An electronic device comprising:
at least one processing device configured to:
obtain a sequence of image frames;
determine one or more color differences and one or more luminance differences for each of one or more overlapping areas between at least one pair of consecutive image frames in the sequence;
generate one or more parameters for a color matching model based on the one or more color differences;
generate one or more parameters for a luminance matching model based on the one or more luminance differences; and
apply the color matching model and the luminance matching model to at least one of the image frames to generate at least one color-matched and luminance-matched image frame.

2. The electronic device of claim 1, wherein the at least one processing device is further configured to:
update a frame registry based on a frame registration of one image frame in the sequence relative to a previous image frame in the sequence;
determine pixel correspondences between the at least one pair of consecutive image frames based on the frame registry; and
determine the one or more overlapping areas based on the pixel correspondences.

3. The electronic device of claim 1, wherein the at least one processing device is further configured to:
optimize the parameters of the color matching model and the luminance matching model; and
store the optimized parameters of the color matching model and the luminance matching model for processing of a subsequent image frame in the sequence.

4. The electronic device of claim 1, wherein, to apply the color matching model to the at least one of the image frames, the at least one processing device is configured to:
generate a color smoothing model based on the one or more parameters of the color matching model;
determine one or more color errors between the at least one pair of consecutive image frames;
apply a minimization algorithm to the one or more color errors to generate one or more parameters of the color smoothing model; and
apply the color smoothing model as a linear correction to the one or more color errors.

5. The electronic device of claim 1, wherein, to apply the luminance matching model to the at least one of the image frames, the at least one processing device is configured to:
generate a luminance smoothing model based on the one or more parameters of the luminance matching model;
determine one or more luminance errors between the at least one pair of consecutive image frames;
apply a minimization algorithm to generate one or more parameters of the luminance smoothing model; and
apply the luminance smoothing model as a gamma correction to the one or more luminance errors.

6. The electronic device of claim 1, wherein, to apply the color matching model and the luminance matching model, the at least one processing device is configured to:
smooth colors between different ones of the image frames; and
smooth luminances between different ones of the image frames.

7. The electronic device of claim 1, wherein:
to generate the one or more parameters for the color matching model, the at least one processing device is configured to apply linear correction in the one or more overlapping areas; and
to generate the one or more parameters for the luminance matching model, the at least one processing device is configured to apply gamma correction in the one or more overlapping areas.

8. A method comprising:
obtaining, using at least one processing device of an electronic device, a sequence of image frames;
determining, using the at least one processing device, one or more color differences and one or more luminance differences for each of one or more overlapping areas between at least one pair of consecutive image frames in the sequence;
generating, using the at least one processing device, one or more parameters for a color matching model based on the one or more color differences;
generating, using the at least one processing device, one or more parameters for a luminance matching model based on the one or more luminance differences; and
applying, using the at least one processing device, the color matching model and the luminance matching model to at least one of the image frames to generate at least one color-matched and luminance-matched image frame.

9. The method of claim 8, further comprising:
updating a frame registry based on a frame registration of one image frame in the sequence relative to a previous image frame in the sequence;
determining pixel correspondences between the at least one pair of consecutive image frames based on the frame registry; and
determining the one or more overlapping areas based on the pixel correspondences.

10. The method of claim 8, further comprising:
optimizing the parameters of the color matching model and the luminance matching model; and
storing the optimized parameters of the color matching model and the luminance matching model for processing of a subsequent image frame in the sequence.

11. The method of claim 8, wherein applying the color matching model to the at least one of the image frames comprises:
generating a color smoothing model based on the one or more parameters of the color matching model;
determining one or more color errors between the at least one pair of consecutive image frames;
applying a minimization algorithm to the one or more color errors to generate one or more parameters of the color smoothing model; and
applying the color smoothing model as a linear correction to the one or more color errors.

12. The method of claim 8, wherein applying the luminance matching model to the at least one of the image frames comprises:
generating a luminance smoothing model based on the one or more parameters of the luminance matching model;
determining one or more luminance errors between the at least one pair of consecutive image frames;
applying a minimization algorithm to generate one or more parameters of the luminance smoothing model; and
applying the luminance smoothing model as a gamma correction to the one or more luminance errors.

13. The method of claim 8, wherein applying the color matching model and the luminance matching model comprises:
smoothing colors between different ones of the image frames; and
smoothing luminances between different ones of the image frames.

14. The method of claim 8, wherein:
generating the one or more parameters for the color matching model comprises applying linear correction in the one or more overlapping areas; and
generating the one or more parameters for the luminance matching model comprises applying gamma correction in the one or more overlapping areas.

15. A non-transitory machine readable medium containing instructions that when executed causes at least one processor of an electronic device to:
obtain a sequence of image frames;
determine one or more color differences and one or more luminance differences for each of one or more overlapping areas between at least one pair of consecutive image frames in the sequence;
generate one or more parameters for a color matching model based on the one or more color differences;
generate one or more parameters for a luminance matching model based on the one or more luminance differences; and
apply the color matching model and the luminance matching model to at least one of the image frames to generate at least one color-matched and luminance-matched image frame.

16. The non-transitory machine readable medium of claim 15, further containing instructions that when executed cause the at least one processor to:
update a frame registry based on a frame registration of one image frame in the sequence relative to a previous image frame in the sequence;
determine pixel correspondences between the at least one pair of consecutive image frames based on the frame registry; and
determine the one or more overlapping areas based on the pixel correspondences.

17. The non-transitory machine readable medium of claim 15, further containing instructions that when executed cause the at least one processor to:
optimize the parameters of the color matching model and the luminance matching model; and
store the optimized parameters of the color matching model and the luminance matching model for processing of a subsequent image frame in the sequence.

18. The non-transitory machine readable medium of claim 15, wherein the instructions that when executed cause the at least one processor to apply the color matching model to the at least one of the image frames comprise:
instructions that when executed cause the at least one processor to:
generate a color smoothing model based on the one or more parameters of the color matching model;
determine one or more color errors between the at least one pair of consecutive image frames;
apply a minimization algorithm to the one or more color errors to generate one or more parameters of the color smoothing model; and
apply the color smoothing model as a linear correction to the one or more color errors.

19. The non-transitory machine readable medium of claim 15, wherein the instructions that when executed cause the at least one processor to apply the luminance matching model to the at least one of the image frames comprise:
instructions that when executed cause the at least one processor to:
generate a luminance smoothing model based on the one or more parameters of the luminance matching model;
determine one or more luminance errors between the at least one pair of consecutive image frames;
apply a minimization algorithm to generate one or more parameters of the luminance smoothing model; and
apply the luminance smoothing model as a gamma correction to the one or more luminance errors.

20. The non-transitory machine readable medium of claim 15, wherein the instructions that when executed cause the at least one processor to apply the color matching model and the luminance matching model comprise instructions that when executed cause the at least one processor to:
smooth colors between different ones of the image frames; and
smooth luminances between different ones of the image frames.
